(19) United States
(12) Patent Application Publication
(10) Pub. No.: US 2010/0119370 A1
(43) Pub. Date: May 13, 2010

(54) INTELLIGENT AND OPTIMIZED WIND TURBINE SYSTEM FOR HARSH ENVIRONMENTAL CONDITIONS

(75) Inventor: Gunnar Myhr, Oslo (NO)

Correspondence Address: KLARQUIST SPARKMAN, LLP, 121 SW SALMON STREET, SUITE 1600, PORTLAND, OR, 97204, US

(73) Assignees: Modi Vivendi AS; Emantec AS

(21) Appl. No.: 12/635,248

(22) Filed: Dec. 10, 2009

Related U.S. Application Data
(60) Provisional application No. 61/261,808, filed on Nov. 17, 2009.

(51) Int. Cl. F03D 7/02; F03D 11/02; F03D 7/00; F03D 9/00

(52) U.S. Cl. 416/39; 416/170 R; 416/169 R; 416/44; 416/61; 416/31; 290/55

(57) ABSTRACT

A wind turbine including a torque distribution device for distributing torque between two different shafts. Also a system for detecting the presence of snow/ice on a wind turbine using ultrasound sensors and a system for de-icing wind turbines in which when the removal of snow/ice is detected, the heaters are switched off. Also a wind turbine with a lightning sensor and a processing unit which can shut down sub-systems or the whole system in response to data from the lightning sensor. Also a wind turbine with an automated lubrication refill system for replenishing the lubricant in one or more components of the turbine. Also a wind farm comprising a plurality of wind turbines in which at least one wind turbine is communicatively coupled to at least one other wind turbine.

### CROSS REFERENCE TO RELATED APPLICATION

This application claims priority from U.S. Provisional Application No. 61/261,808, filed Nov. 17, 2009, which application is incorporated herein by reference in its entirety.

### FIELD

This is an invention concerning an intelligent and optimized wind turbine for providing an increased power output and increased regularity even when operated in harsh environmental conditions such as snow and ice, lightning, variable wind velocities, storms and extreme temperatures with optional additional features including an intelligent lubricating system and the ability to transmit or receive data to/from other wind turbines or from external control centers.

The terms “windmill” and “wind turbine” are synonymous concepts throughout this document.

### BACKGROUND

Recently, increased attention has been paid to the possible adverse consequences of CO₂ emissions from fossil fuels and this has brought renewable energy sources in general and wind power in particular into focus.

For various reasons, including topography, aesthetic considerations, wind strengths and directions, it has often become desirable to locate wind turbines in remote locations out of sight of populated or scenic areas. Remote locations on land or offshore (sea or large lakes) have been considered. Offshore wind turbines may be floating or fixed on the seabed. The remote locations which are often best for wind turbines are often subject to harsh environmental conditions like heat, low or high humidity, sand, rain, snow, lightning, changing wind directions and changing wind speed, excessive wave heights (in offshore locations), extreme wind velocities and temperatures and/or heat transfer conditions. These harsh conditions can cause structural and/or mechanical failures, and they can lead to the creation of ice and/or snow on the rotor blades, the structure and/or the nacelle. Wind turbines in such remote locations are also susceptible to being struck by lightning.

A detailed discussion of wind turbines and the aerodynamics thereof is given in “Harvesting the Wind: The Physics of Wind Turbines” by Kira Grogg (available at http://digitalcommons.carleton.edu/pacp/7). Relevant portions of this analysis are outlined below.

A wind turbine is essentially a very large, inverse fan. Wind turbines usually have three blades, but can be equipped with one, two, four or more blades. The axis of rotation of the blades may be either horizontal or vertical. For a horizontal axis wind turbine (HAWT), the plane of the rotor turns so that the wind is perpendicular to it, and can flow around the blades to make them rotate around the hub. For a vertical axis wind turbine (VAWT), the plane of rotation is parallel to the wind flow. HAWT are more common due to the higher efficiencies that can be achieved.

Modern wind turbines can range from 40 to 100 m or more in height and they can have rotor lengths of 25 to 50 m or more. Wind turbines can be designed to reach power outputs of 3.5 MW. For a general view and description of the primary components of modern wind turbines see FIG. 1.

### Electricity Generation and Control Mechanisms

For horizontal axis wind turbines, a prerequisite for optimization is the ability to turn to face the wind direction. This is known as yawing. Precise electronic controls, motors, gears, and large bearings act together to make sure that the turbine remains facing the wind. Sensors measure the wind direction and are used to control the yawing of the turbine to optimize orientation.

Wind turbines can be used on their own as a single unit or a plurality of wind turbines can be combined together in a wind farm. Single units are sometimes used to provide power in isolated locations where there is no connection to a national power grid. However in many applications it is desirable to take the generated electricity and feed it into a power grid.

To connect the produced electric power to the grid, one approach requires that the rotor turn at a relatively constant speed. However because the wind is hardly ever constant, the blades must then change the angle of attack so as to catch just the right amount of wind power to turn the rotor at the desired constant speed (the rotor speed is typically chosen according to an optimal tip speed ratio). The cut-out wind speeds are typically in the range of 20 to 32 m/s, while cut-in speed is about 5 m/s.

Various types of wind control mechanisms exits. Pitch-controlled turbines rotate their blades to smaller angles of attack to get less lift as wind speed increases. At the cut-out wind speed the blades turn their edges fully into the wind (essentially an angle of attack of zero) to eliminate lift and stop the rotor's motion. Alternatively, stall-controlled blades are able to regulate the rotational speed using a twist along the span so that when the wind speed starts getting too high, the lift drops at the base of the blade because the angle of attack increases. A third type of blade, the active stall, combines the two techniques. The blades rotate about the span-length axis to control rotor speed, but they also use an increasing angle of attack as do stall-controlled blades. To stop the turbine, the blades are shifted into a high stall position, rather than being turned to a zero angle of attack.

Wind turbines have one of two types of generators: synchronous or the more common asynchronous induction generator. Asynchronous generators are useful because the slip allows them to decrease or increase speed if the torque varies, which means less wear on the gearbox and a higher quality output.

For most wind turbines, connection to the grid is made directly from the generator, after using a transformer to step up the voltage to match that of the grid. Variable speed wind turbines require an indirect connection because the current generated is of varying frequency. This problem can be overcome by converting to DC and then converting back to fixed frequency AC. Variable speed turbines can capture slightly more of the wind's power than fixed speed turbines and the indirect connection is often of higher quality. However the additional power gained is offset by the extra cost of the power electronics and losses during the conversions.

A particular problem for wind turbines located in harsh environments with high winds and cold temperatures is the formation of snow and/or ice on the turbine structures (including the rotor blades, the hub, the nacelle and/or the tower structure). Ice/snow sticks to the turbine blades which changes the profile of the blades and alters the aerodynamics of the system. Additionally, the added ice/snow adds weight to the system, reducing its efficiency. Further problems occur when snow/ice builds up unevenly on the rotor blades or if it builds up evenly, but later a portion breaks off so as to leave an imbalanced weight distribution on the rotor blades. This imbalance can be very significant, causing the whole rotor assembly to wobble as it rotates. This increases the wear on bearing components and can cause uneven torque within the system. The stresses caused by such an imbalance are cyclic stresses which can quickly lead to fatigue of the components and costly repairs. A further problem is that large ice deposits breaking off from the rotating blades can be dangerous both to people on the ground or to buildings nearby. It is therefore desirable to avoid the build up of snow/ice and/or to get rid of deposits which have formed.

Due to their height, modern wind turbine structures are susceptible to strokes of lightning. A stroke of lightning can involve extremely strong currents with a magnitude of 10 to 200 kA within a very short period of time. Such exposures can cause interruptions of power production due to blown fuses or in more extreme cases because of severe damage to the blades or to the entire structure.

A concept for direct AC grid integration of a variable speed wind turbine has been developed without the application of any power electronics converter. Variable speed operation of the turbine is mechanically achieved by a hydro-dynamically controlled gear box with continuously controllable variable gear box ratio.

(Mûller, H. et al. Grid Compatibility of Variable Speed Wind Turbines with Directly Coupled Synchronous Generator and Hydro-Dynamically Controlled Gearbox.

Sixth Int'l Workshop on Large-Scale Integration of Wind Power and Transmission Networks for Offshore Wind Farms, 26-28 Oct. 2006, Netherlands).

In FR 2874669 a method involving acquiring wind energy using a primary vertical axis wind turbine to drive a high pressure pump e.g. oil pump is described. A fluid pressurized by the pump is sent in a closed circuit towards a secondary turbine integrated with a gyroscopic flywheel such that the energy taken from the wind and transported by the fluid is accumulated by the flywheel and can later be utilized mechanically.

In JP 2002155850 a wind power generating system is described, constituted as to drive a generator by accelerating the rotation of a wind turbine to a prescribed rotation speed by an accelerator. A flywheel mitigating the rotational fluctuation of the generator is mounted on the rotary shaft of the generator and is characterized in corresponding to the output and the rotational fluctuation of the wind power generation system.

A deicing technique comprising a laminate of a heat-conducting material has been developed by Kelly Aerospace Inc. An (add on) zoned heater system is utilized in a variety of lengths, widths, and thicknesses to match available power. The impingement area, or leading edge of the rotor blade is kept warm, continually melting impinging ice, or simply, “runs wet”. During a de-ice cycle the voltage is increased, raising the temperature of this shed zone. The system measures relative humidity, blade temperature and ambient temperature to determine when to de-ice. (see http://www.kellyaerospace.com/wind_turbine_deice.html)

WO 98/53200 discloses a wind turbine blade which can be deiced by means of heating elements comprising electrically conducting fibres. The heating elements can be arranged on the outside of or embedded in the wind turbine blade, with the objective to melt ice coatings.

US 2005/276696 discloses a method for detecting ice on a wind turbine rotor including monitoring meteorological conditions and preferably bending moments with the use of strain gauges, to determine mass abnormalities consistent with icing. An equivalent approach is described in US 2009/0246019.

WO 98/01340 describes a method and system for avoiding icing of windmill wings of composite materials, with the use of microwave energy for heating of the composite material itself. The energy is preferably supplied from the interior by fixed mounted microwave generators in response to detection of potential climatic conditions for icing to occur.

WO 96/07825 discloses a lightning protection system for wind turbine blades, where the blade tip has been provided with a so-called lightning receptor of electrically conducting material. This lightning receptor can “catch” a stroke of lightning and lead the lightning current downwards through a conductor.

U.S. Pat. No. 6,612,810 combines the features of lightning conductance and de-icing by providing first and second electric conductors extending in the longitudinal direction of the blade together with one or more electric heating elements for heating the surface of the blade, and a lightning receptor at the tip of the wind turbine blade with a third electric conductor, the first and second electrical conductors being connected to the third electrical conductor and to ground via spark gaps. The power supply is protected from lightning by over-voltage cut-outs.

WO 2009/106610 describes a wind turbine with a bearing supporting a hub carrying rotor blades. The bearing comprises a rotational bearing race connected to the hub and a stationary bearing race, a lubrication area between the bearing races which area is confined at both ends by first seal rings sealing the gap between the rotational bearing race and stationary parts to form a lubrication barrier.

In EP 2063112 a wind turbine comprises a receiver adapted to receive a signal from a satellite-based navigation system and to determine at least one of a position information, a time information and a date information from the signal, and a communication device adapted to transmit the information determined by the receiver to a recipient location.

### Engineering and Physical Aspects of Wind Turbines

Due to the law of conservation of linear momentum it can be proven that the power, P, extracted from the air, for a wind turbine, can be expressed as:

P=½AρU³4a(1−a)² (A1)

Where

a=the axial induction factor, defined as:

a≡(U−U₁)/U)

A=rotor area=πR², R=rotor length

ρ=density of air

U=free stream velocity

U₁=velocity at the rotor blade

A performance power coefficient, Cₚ, can be defined as the ratio of the power in the rotor to the power in the wind:

Cₚ=4a(1−a)² (A2)

An analysis yields a maximized axial induction factor of ⅓, providing a maximum power coefficient of ≈0.59 or 59% (Betz's Limit).

A more thorough analysis takes into account the rotating wake created by the rotor. Based on the law of conservation of angular momentum, the blades have an angular velocity, Ω, relative to the linear wind, but an angular velocity relative to the wake equivalent to Ω+ω, where ω is the angular velocity of the wake relative to the linear wind.

Introducing an angular induction factor, defined as a′≡ω/2Ω, provides the expression:

λᵣ²=[a(1−a)]/[a′(1+a′)]=[Ω²r²]/U² (A3)

Where

λᵣ is the local speed ratio, i.e. the ratio of the rotor speed at radius r to the wind speed at distance r from the hub.

When r=R (where R is the length of the blade),

λ_{R}=ΩR/U=λ, the tip speed ratio (A4)

Subsequently, a more complete power coefficient can be derived:

Cₚ=8/λ²Inta′(1−a)λᵣ²dλᵣ (A5)

Where

Int is the integral from 0 to λ

Also,

Power=Torque*angular velocity (P=Q*Ω) (A6)

Q=Mass moment of inertia*angular acceleration

Q=Iₘ*α=½IₘΩ³ (A7)

Iₘ can be modeled or experimentally determined.

The bending moment of the blade, M, can be expressed as:

M(r)=w/2(L−r)² (A9)

or M=Intr[4a(1−a)ρπU²rdr] (A10)

Where

w=force per unit length

L=length of blade

r=distance from the root

Int=integral from 0 (base of the rotor) to R

The amount of lift for a given airfoil depends heavily on the angle that it makes with the direction of the relative wind, known as the angle of attack. With a certain range, an increased angle of attack means increased lift, but also more drag, which detracts from the desired motion. The thrust changes along the span and is usually stronger near the tip of the blade. Changing the angle of attack is important to maintain a precise amount of lift, thus causing the rotor to turn at a constant speed.

Empirical or computational tests are used to determine the lift and drag for a given airfoil (rotor blade). The lift and drag coefficients (Cₗ and C_{d}) are defined as the lift or drag force per unit length divided by the dynamic force per unit length.

The rotor on a wind turbine rotates, so that while the entire blade has the same angular velocity, the tangential velocity increases with increased radius, as does the relative wind. Similarly, the axial and angular induction factors are functions of radius r because they can change along the span of the blade.

The thrust on an annular section r from the center is given by the vector addition of the lift and drag forces (adding the components perpendicular to the plane of rotation). The tangential force, which provides torque, can be found from the vector addition of lift and drag (adding the components parallel to the plane of rotation). Drag decreases torque, so one often seeks to minimise the C_{d}/Cₗ ratio.

### SUMMARY

The present invention applies to horizontal or vertical wind turbine systems comprising a rotor with one or a multiple of blades. Preferred embodiments of the invention have three rotor blades. A preferred embodiment of the invention is a horizontal axis wind turbine with a rotor hub, a nacelle, a yaw mechanism and a tower structure enabling the rotor system to be elevated in the air.

The materials for the various parts of the system can include one or more of metals, alloys, plastics, polymers, fiber glass, wood and composite materials. Due to favourable weight, strength, corrosion and age features, composite materials are generally preferred.

The entire system may have a pitch control mechanism for controlling the angle of the rotor blades and for stabilizing the rotor tip speed (angular velocity).

All gears within the system can be fixed gears or variable gear boxes or combinations thereof.

With reference to FIG. 1, a typical horizontal axis wind turbine comprises, among other components, high and low speed shafts (the low speed shaft being driven directly by the rotor and the high speed shaft being the output of a gearbox which steps up the speed of the low speed shaft for power generation), brakes (to hold the various movable mechanisms steady when movement is not desired), yaw drives, yaw motors, generators, an anemometer and one or more controllers.

According to a first aspect, the present invention provides a wind turbine comprising: a rotor with one or more blades; a first shaft rotatably driven by the rotor; a second shaft; a third shaft; and a torque distribution device which distributes the torque from the first shaft between the second shaft and the third shaft.

The third shaft of the wind turbine system may be used for a number of different purposes. For example, it may be used as a mechanical output to drive mechanical machinery. However, preferably the third shaft drives a generator for generating electricity. Electricity can either be used directly, transferred elsewhere locally, stored for later use or transmitted further afield, preferably by feeding the generated electricity into a power grid so as to be combined with electricity generated elsewhere.

The third shaft may drive a gearbox which increases the rotation speed and which drives the generator. The wind turbine rotor, driven by the wind, typically rotates at a fairly low rotational speed, e.g. around 6 to 20 revolutions per minute. However, electricity generators typically operate more efficiently at higher rotational speeds. Therefore a gearbox placed in the drive train between the rotor and the generator which takes a low input rotational speed and outputs a higher rotational speed increases the efficiency of the system. As an alternative to placing the gearbox between the torque distribution device and the system output (e.g. the generator), the gearbox may be placed between the rotor and the torque distribution device.

The two outputs of the system may be simply split so that they both vary in proportion to the speed of the main turbine rotor. However preferably one of the outputs (most preferably the third shaft) can be set to rotate at a desired fixed speed. It is often desirable for an output of the system to be consistent. This can be particularly important for electricity generation where the electricity is to be fed into a power grid as the electricity generated by the wind turbine needs to be of a certain frequency and of a high consistency, i.e. it needs to generate a regular power output from an irregular energy source (the wind). By using a torque distribution means, the power (i.e. the torque) generated by the rotor can be divided into a main part which is required for the main output (the third shaft) and a remainder part which can be used for other purposes. In this way, the speed of the rotor need not be controlled in order to control the output, but instead the rotor can be allowed to speed up when the wind speed increases. Therefore the energy associated with the increased wind speed is not lost, but is diverted into the secondary output (the second shaft) and can still be utilized or stored. The torque distribution device may be arranged to transfer a fixed power to the third shaft and to transfer any remaining power to the second shaft.

In another alternative embodiment, the rotational speed of the third shaft may be allowed to vary, the third shaft may drive a generator for generating electricity and a frequency conversion system may be attached to the generator to generate electricity at a fixed frequency.

Preferably the torque distribution device is a differential gear. More preferably, the torque distribution device is an active differential gear. The active differential gear may be controlled by a processing unit so as to determine the split in torque between the second shaft and the third shaft.

Although the system may, for mechanical simplicity provide direct connections between the various components, preferably a first clutch mechanism is provided which allows the third shaft to be engaged and disengaged from the first shaft. There may be times when the output of the third shaft is not required or when it is desired to disengage it from the wind turbine, e.g. for maintenance, without interrupting the wind turbine. While the third shaft is disengaged from the first shaft, the torque distribution means may distribute more (or all) of the torque from the main rotor to the second shaft. Thereby the available power of the wind turbine is not wasted even when the third shaft is disengaged. Alternatively, the torque distribution means may be arranged to maintain the power transmitted to the second shaft and to waste any remaining power. This would be necessary where a fixed output was required from the second shaft.

Preferably a second clutch mechanism is provided which allows the second shaft to be engaged and disengaged from the first shaft. There may be times when the output of the second shaft is not required or when it is desired to disengage it from the wind turbine, e.g. for maintenance, without interrupting the wind turbine. While the second shaft is disengaged from the first shaft, the torque distribution means may distribute more (or all) of the torque from the main rotor to the third shaft. Thereby the available power of the wind turbine is not wasted even when the second shaft is disengaged. Alternatively, the torque distribution means may be arranged to maintain the power transmitted to the third shaft and to waste any remaining power. This would be necessary where a fixed output was required from the third shaft.

The second and third shafts may be provided as completely separate systems, each driven from the first shaft. However, there may be times when it is desirable to interconnect the two systems. Therefore, preferably a third clutch mechanism is provided which allows the second shaft to be engaged and disengaged from the third shaft. Such a system could be useful where the second shaft is used to store excess energy and where it is later desirable (e.g. because of a reduction in wind power) to use that stored energy to drive the third shaft instead of using the first shaft.

Preferably the first clutch is arranged to disengage the third shaft from the first shaft when the angular velocity of the first shaft drops below a threshold value. Similarly, the second clutch may be arranged to disengage the second shaft from the first shaft when the angular velocity of the first shaft drops below a threshold value. When the first shaft drops below a certain threshold angular velocity (the level of which will depend on the particular circumstances), the wind turbine may no longer be able to support both of the systems attached to the second and third shafts. It will therefore be advantageous to divert all power to one system which is deemed more important and to disengage the other system. The first second and third clutches may be controlled by one or more processing units.

In a preferred embodiment, a flywheel is driven by the second shaft. A flywheel can be used to store excess energy generated by the wind turbine over and above that which is required by the system of the third shaft. The ability to store excess energy allows the wind turbine to take advantage of higher wind speeds and allows the wind turbine to operate at a higher efficiency.

The energy stored in a flywheel may be utilized in a number of ways. For example, it may be used directly to drive mechanical machinery. However, in one embodiment a second generator is provided which can be selectively driven by the flywheel. The flywheel can therefore be used to generate electricity. This electricity can be used directly or can be fed into a power grid for use further afield. The electricity generated from the flywheel may be fed directly into the grid or a frequency conversion system may be provided to convert the electricity to a different (preferably fixed) frequency. Preferably the second generator can be engaged and disengaged from the flywheel by means of a fourth clutch mechanism.

In preferred embodiments of the invention, the flywheel is housed in a low pressure chamber in order to reduce the drag on the flywheel, thus increasing the efficiency of the system.

Preferably the second and/or the third shaft is fitted with sensors for the measurement of at least one of: torque, radial forces, angular velocity, angular acceleration, temperature and humidity. More preferably the sensors supply data to a processing unit. The data from such sensors may be used to assess the system (or systems) attached to the shaft and to monitor the state of such systems. For example, the sensors may be used to determine how much energy is stored in a flywheel (when combined with known data such as the mass and dimensions of the flywheel and various coefficients of friction which may be calculated, modelled or determined empirically) and also to determine when maintenance of the system may be required, e.g. by monitoring temperature and/or humidity which may lead to corrosion. Similarly, the or each system may be monitored to measure or to estimate power output and/or to determine if it is operating correctly or if maintenance is required. For example, an angular velocity sensor can be used to check that a generator is being driven at the correct speed or a force sensor can be used to detect vibrations or wobbles in the shaft which may indicate mechanical problems either with the torque distribution device or with the system (e.g. generator) attached to the shaft.

The wind turbine may be a vertical axis wind turbine. However, the wind turbine is preferably a horizontal axis wind turbine, the rotor being mounted on a nacelle which in turn is rotatably mounted on a tower structure. As described above, horizontal axis wind turbines generally provide higher efficiencies as the rotor can be raised high above the ground where wind speeds are higher and more consistent and because the rotor blades interact with the wind throughout their whole cycle of rotation.

In one preferred embodiment the flywheel is located in the nacelle. This provides mechanical simplicity. In another preferred embodiment the flywheel is located near the base of the tower structure and is connected through a hydraulic transmission system. This has the advantage of keeping large heavy components near to the ground which makes assembly of the wind turbine easier as well as simplifying maintenance. It also allows a larger flywheel to be used.

According to a further aspect, the invention provides a system for detecting the presence of snow and/or ice on a wind turbine, the system comprising: one or more ultrasound sensors arranged to monitor the surface of the turbine structure.

In a preferred embodiment, the or each ultrasound sensor is arranged to send data to a processing unit. The processing unit can collect and monitor the sensed data to measure both spatial and temporal differences and trends. This data can be used to assess the spatial and temporal distribution of snow and/or ice formation on the wind turbine. As described further below, the processor may be arranged to take action according to the sensed data.

Sensors may be positioned at various positions and in various numbers on the wind turbine, depending on the type and construction of the wind turbine. In preferred embodiments the wind turbine comprises a rotor with one or more blades and at least one ultrasound sensor is arranged to monitor the surface of each rotor blade. The rotor blades are most influenced by the presence of snow and/or ice as the snow/ice can alter the aerodynamic profile of the blades, thus altering the lift that they can generate and thereby reducing the efficiency of the blades. Also, if snow/ice builds up unevenly or if an uneven distribution results from snow/ice breaking off asymmetrically from a plurality of blades then the weight of the snow/ice can impose a cyclic strain on the components of the turbine, e.g. the blades, the hub, the rotor shaft, and the main body of the turbine structure. These cyclic stresses can quickly cause excessive wear on the components, particularly on bearings between rotating components and stationary components and can result in the need for maintenance much earlier than it would otherwise be needed. In the worst cases, damage to the blades and/or the main structure can result. Additionally, due to the height of some turbines, snow/ice breaking off from rotor blades can be dangerous both to people on the ground and to other structures (buildings or neighbouring turbines).

In preferred embodiments the wind turbine comprises a nacelle on which a rotor is mounted and at least one ultrasound sensor is arranged to monitor the surface of the nacelle. The nacelle is also a critical component of the system in that it rotates the turbine blades into the wind so as to increase the efficiency of the system. It is therefore important to ensure that the nacelle is not obstructed by snow/ice.

In preferred embodiments the wind turbine comprises a tower structure on top of which a rotor is mounted and at least one ultrasound sensor is arranged to monitor the surface of the tower structure. Although the tower itself is not as severely affected by the presence of snow/ice, it is still desirable to monitor the tower structure for the presence of snow and/or ice. If a large amount of snow and/or ice builds up on the tower, or on one side of the tower, this can become a risk to the rotating blades. In high winds and at high operational speeds, the rotor blades bend backwards towards the tower. It is therefore very important to ensure that the blades do not contact the tower and that they do not contact any snow/ice build up on the tower. It is therefore important to minimise the build up of snow/ice on the tower or at least to be aware of the thickness of any such build up.

In preferred embodiments, the or each ultrasound sensor is arranged inside the structure and is arranged to monitor the thickness of the surface and any surface deposits. Ultrasound is particularly suitable for detecting changes in material as reflections are generated at boundaries between two different media with different acoustic impedances. These reflections (echoes) can be detected and the presence and characteristics of different materials and their thicknesses can be detected and calculated. Ultrasound sensors arranged inside the structure can therefore detect the thickness of the structure itself as well as the thickness of any deposits on the outside of the surface.

As an alternative to the above, ultrasound sensors may be arranged on the surface of the structure and arranged to monitor the thickness of any surface deposits. Placing the ultrasound sensors on the outside of the structure makes fitting and maintenance simpler, but leaves the sensors more exposed to the elements and therefore may increases the need for maintenance.

Embodiments of the system may further comprise a torque sensor and/or a force sensor and/or an angular velocity sensor and/or an angular acceleration sensor for sensing physical parameters of a main shaft of the wind turbine and the or each sensor may send data to a processing unit. The effect of ice/snow (or other deposits) on the wind turbine structures will depend on other physical factors such as the speed of rotation of the rotor or the strain (e.g. the bending moment) of the blades. For example, a small amount of snow/ice may not be considered significant at lower speeds, but could be problematic at higher speeds.

Embodiments of the system may further comprise one or more strain sensors for sensing the strain in the turbine structure and the or each sensor may send data to a processing unit. The or each strain sensor may be an ultrasound sensor. Imbalances in one part of the system can quickly be transmitted to other parts of the structure so it is important to monitor the strain in various different parts of the structure.

Embodiments of the system may further comprise a wind speed sensor and/or a wind direction sensor and/or a temperature sensor and/or a humidity sensor for sensing environmental parameters and the or each sensor may send data to a processing unit. The environmental parameters may be usefully combined with the physical parameters to determine whether or not the sensed physical parameters are indicative of the presence of snow/ice or whether they could be due to other influences. For example, a sensor may detect the presence of a deposit on the structure, but the temperature and/or humidity sensors may indicate that the sensed deposit cannot be snow/ice. The sensed environmental data can therefore be useful in determining what, if any, corrective action should be taken.

Preferably the processing unit is arranged to analyse the data and to determine whether or not ice and/or snow may be present on the turbine structure.

Preferably the system further comprises one or more heating elements. Heating elements can be positioned at various points throughout the structure of the wind turbine, such as in the rotor blades, the nacelle and/or the tower structure. The heating elements may be located in the substantially the same places as the ultrasound sensors. Heating elements take a significant quantity of electricity to operate and so they are preferably selectively operable so that heating is only applied where and when it is required. Preferably the or each heating element is arranged to be operated only when snow and/or ice is detected in the vicinity of that heating element.

The or each heating element is preferably an ultrasound transmitter. Ultrasound provides a simple mechanism for applying heat rapidly and in an energy efficient manner. Ultrasound can also easily be focused at a specific location using shaped transmitters, lenses or beam forming techniques. Ultrasound energy therefore need not be wasted in heating parts of the structure which do not require heating. This also reduces the potential damage to the structure which could result from repeated thermal cycling.

Preferably the or each heating element is an ultrasound transducer and also serves as one of the sensors for monitoring the surface of the structure.

The heating elements could be individually controlled in situ by the corresponding sensor or a combination of local sensors together with local processing units. However, as mentioned above, it is preferred to provide all sensor data to a central processing unit which can perform more detailed analysis based on all of the environmental and physical sensor data and which controls each of the heating elements accordingly. In this way a more accurate assessment can be made.

Combining the different aspects of the invention described above, A wind turbine may be provided wherein the or each heating element is powered from a flywheel.

According to a further aspect of the invention, there is provided a wind turbine comprising: at least one sensor for sensing the presence of snow and/or ice on the surface of the wind turbine in real time; at least one heating element for melting snow and/or ice on the surface of the wind turbine; and a processing unit arranged to receive data from the at least one sensor and arranged to activate and deactivate the heating element; wherein the processing unit is arranged to activate the heating unit when the at least one sensor indicates the presence of snow and/or ice and wherein the processing unit is arranged to deactivate the heating unit when the at least one sensor no longer indicates the presence of snow and/or ice.

By monitoring the surface of the wind turbine (particularly the rotor blades, but preferably also the nacelle and/or tower structure) in real time the system can detect not only the presence of material adhering to the surface of the turbine, but can also detect the absence of such material. The heating elements can therefore be switched on only when they are required and can be switched off as soon as they are no longer required, i.e. as soon as the sensors no longer sense the presence of material. Heating of wind turbines can take a significant amount of energy and therefore it is desirable to minimise the amount of energy expended in heating. It is therefore advantageous to be both spatially and temporally selective in the activation of heating elements.

As discussed above, a number of different sensors can be used to detect the presence of snow/ice on the turbine surfaces. For example force and torque sensors monitoring the rotor can sense a mass increase or a mass imbalance caused by the presence of snow/ice. From this data it is possible to calculate the quantity and position of snow/ice on the rotor. However, preferably the at least one sensor includes at least one ultrasound sensor arranged to monitor the thickness of snow and/or ice on the surface of the wind turbine. The ability to measure the thickness (and thereby the presence or absence) of snow/ice directly facilitates location determination. This means of location does not depend on the rotor being in operation, but can be used even when the rotor is stationary.

Any heating elements such as electric resistance heaters or hot air blowers may be used to provide heat. However preferably the at least one heating element includes at least one ultrasound transmitter. As discussed above, ultrasound can be readily focused on to a particular region and can be accurately controlled and switched on and off rapidly.

In a preferred embodiment the at least one sensor includes at least one torque sensor and/or force sensor and/or angular velocity sensor and/or angular acceleration sensor and/or strain sensor arranged to monitor a rotor of the wind turbine. The provision of extra sensor data allows for a better overall assessment of the wind turbine as a whole and allows better identification of problems.

Preferably all of the sensors provide data to a processing unit which then controls the heating elements according to a spatial and temporal analysis of the presence of snow/ice on the turbine surfaces.

According to a further aspect of the invention, there is provided a wind turbine comprising a lightning sensor for detecting the presence of lightning and sending data to a processing unit, wherein the processing unit is arranged to shut down one or more components or sub-systems of the wind turbine or the whole wind turbine for a defined period of time based on the data received from the lightning sensor.

Wind turbines are often located in remote areas where winds are high and the weather conditions are frequently stormy. There is therefore a correspondingly increased risk of lightning strikes. The rotor blades being the highest parts of the structure and also having a pointed shape are particularly susceptible. As will be appreciated from the above description, modern wind turbines often contain sophisticated electronics for controlling various aspects of the turbine systems such as the yaw control mechanisms, de-icing mechanisms, rotor blade control (angle of attack adjustment) and fault detection. There are also a large number of sensors whose data must be monitored and processed by one or more processing units. All of these electrical systems are at risk from the high voltages and currents produced by a lightning strike. It is therefore desirable to protect theses systems when a lightning strike is detected or when environmental conditions are such that lightning strikes are likely. In some circumstances (depending on the operating conditions) it may be sufficient to electrically isolate selected systems. In other circumstances it may be necessary to shut down the entire system. For example, where it is desirable not to interrupt electricity generation and where the environmental conditions are such that de-icing is not likely to be required, the de-icing system and sensors could be isolated and maybe also the fault detection systems while the turbine is still allowed to operate and generate electricity. In other circumstances it may be better simply to shut down the entire system, parking the turbine blades in the most favourable position, e.g. in a system of three rotors, with one of the blades pointing downwards in line with the tower structure.

The lightning sensor may be one or more sensors. The lightning sensor may include a voltage sensor and/or a current sensor connected to a lightning conductor within the structure (e.g. within rotor blades or within the nacelle or the tower structure). Alternatively or additionally the lightning sensor may include other environmental and/or physical sensors within the system such as wind speed, wind direction, humidity.

The processing unit is preferably arranged to perform the shutdown when the sensed data is outside a predetermined range.

According to a further aspect, the present invention provides a wind turbine comprising: one or more lubricated components; a lubrication refill system; and one or more sensors for monitoring the lubricant level in the or each lubricated component; wherein the lubrication refill system is arranged to refill the or each component with lubricant when the or each sensor indicates that the lubricant level has fallen below a threshold value.

Because of the remoteness of many wind turbines, maintenance and repair is expensive as special repair teams have to be sent out long distances and in harsh environmental conditions to make repairs in the field. One particularly common maintenance task is to keep the various moving parts well lubricated. If the systems are kept well lubricated, then other maintenance and repair jobs can be minimised. According to the present invention, a lubrication refill system is provided which can automatically accomplish this task. The system can store a reserve of lubricant in a reservoir and is provided with sensors which sense the lubricant level of the various components. When the lubricant level is sensed to be low, refill from the reservoir can be performed automatically thus saving the maintenance team from being sent out. Such an automated system is also more reliable as refills take place automatically rather than being reliant on the availability of staff and the environmental conditions being suitable for maintenance to be carried out. Additionally, the system need not be interrupted in order for the automatic refilling to be carried out.

It will be appreciated that the above various aspects of the invention may be incorporated into a wind turbine system alone or in combination. Preferred embodiments of the invention will include more than one of the above aspects, most preferably all of them. In particular it will be appreciated that the various sensors employed for the various aspects of the invention have significant overlaps and when more than one aspect of the invention is employed, the sensor data can be used for the functioning of both aspects. Preferably the various sensor data for the different aspects of the invention are provided to a central processing unit and the central processing unit is arranged to issue various control signals for putting the various aspects of the invention into effect.

According to a further aspect of the invention, there is provided a wind farm comprising a plurality of wind turbines, wherein at least one wind turbine is communicatively coupled to at least one other wind turbine.

The ability of wind turbines within a wind farm to communicate with each other has many benefits. For example, the wind speed and/or direction may vary across the area covered by a wind farm as well as other factors such as temperature or humidity. The ability to exchange such information can lead to better overall analysis of the environment and better identification of dangerous conditions. For example a dangerously strong wind may be sensed at one side of a wind farm before it reaches the other side. The ability to transmit sensor data indicating such conditions may allow sufficient time for preventative action to be taken on the other side of a wind farm before the strong wind arrives (e.g. parking the rotors).

Additionally, in remote locations (especially off shore), it may be relatively straight forward and reliable for wind turbines within a wind farm to communicate with each other. However, it can be expensive to provide reliable communications equipment enabling wind turbines to communicate with a distant control centre (typically on shore). Therefore in a preferred embodiment, the ability of wind turbines within a wind farm to communicate with each other allows one wind turbine to act as a gateway to the control centre. That master (gateway) wind turbine may be communicatively coupled with the control centre by provided it with communications equipment for long distance communication. The wind farm may then be arranged for each wind turbine on the farm to send and receive data to/from the control centre via the master wind turbine, i.e. a (non-master) wind turbine sends data to the master wind turbine which then passes that data on to the control centre. Similarly, commands and/or data directed for a particular wind turbine may be sent from the control centre to the master wind turbine which can then direct such commands and/or data to the relevant wind turbine on the farm. In this way only one set of long distance communications equipment is required per wind farm.

For the sake of redundancy, more than one master wind turbine (and more than one set of long range communications equipment) may be provided.

Depending on the costs and the particular situation, each wind turbine may be connected only to the master wind turbine. However, preferably the wind turbines are communicatively networked so that they can each exchange data with each other as well as with the master wind turbine. Communications may be provided wirelessly (e.g. by radio transmission) or via wired connections.

Preferably at least one master wind turbine is arranged to transmit and receive data to/from the control centre and is arranged to transmit and receive data to/from each other wind turbine in the farm. Preferably each wind turbine is communicatively coupled to each other wind turbine on the farm. Preferably the plurality of wind turbines are communicatively networked for exchange of data.

The invention also extends to various methods in accordance with the various systems described above.

The invention provides a method of dividing the energy of a wind turbine comprising feeding the torque from a rotor into a torque distribution device which divides the torque between two output shafts.

The invention provides a method of detecting the presence of snow and/or ice on a wind turbine comprising monitoring the surface of the turbine structure with one or more ultrasound sensors.

The invention provides a method of removing snow and/or ice from the surface of a wind turbine comprising the steps of: sensing the presence of snow and/or ice on the surface of the wind turbine in real time with at least one sensor; processing the data from the at least one sensor; activating at least one heating unit when the sensed data indicates the presence of snow and/or ice; and deactivating the at least one heating unit when the sensed data no longer indicates the presence of snow and/or ice.

The invention provides a method of protecting a wind turbine from lightning comprising sensing the presence of lightning using a lightning sensor and shutting down one or more components or sub-systems or the whole wind turbine for a defined period of time based on data from the sensor.

The invention provides a method of maintaining lubrication levels in a wind turbine comprising sensing the lubricant level in one or more lubricated components and refilling the or each component with lubricant when the lubricant level is sensed to fall below a threshold value.

The invention provides a method of controlling a plurality of wind turbines in a wind farm comprising at least one wind turbine of the plurality of wind turbines sending and/or receiving data from another wind turbine of the plurality of wind turbines.

It will be appreciated that all of the features described above and below in relation to the various systems apply equally to the various methods.

### BRIEF DESCRIPTION OF THE DRAWINGS

FIG. 1 schematically shows the various components of a typical horizontal axis wind turbine;

FIG. 2 schematically shows an embodiment of the invention with a flywheel and a differential gear;

FIGS. 3a and 3b show turbine blades with various sensors.

FIG. 4 shows a wind turbine with various sensors according to the invention.

FIG. 5 shows a wind turbine according to another embodiment.

### DETAILED DESCRIPTION

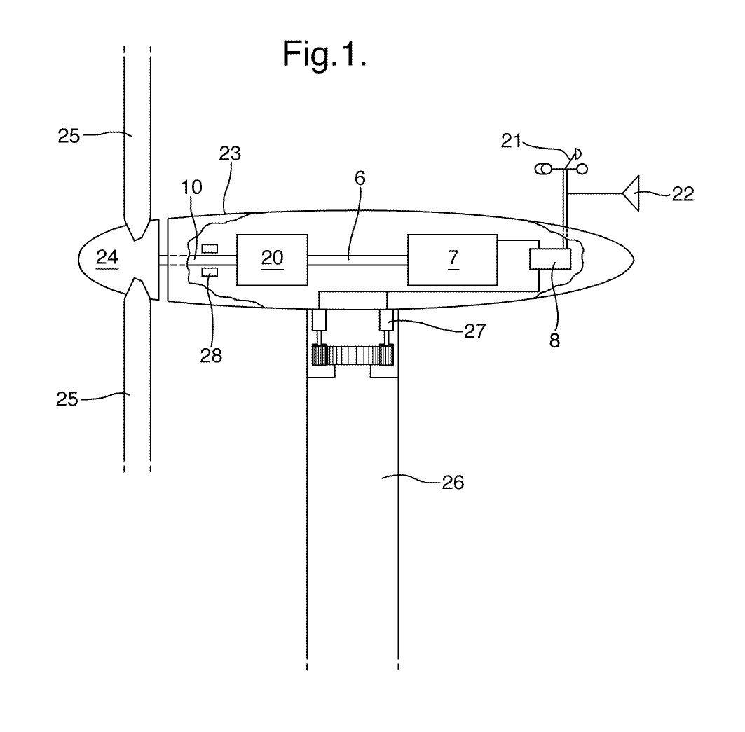

FIG. 1 shows the components of a typical horizontal axis wind turbine. A tower structure 26 supports a nacelle 23 which includes various components for generating power. At the front of the nacelle 23, a hub 24 is rotatably mounted. The hub 24 is provided with a plurality (typically three) of rotor blades 25. Rotor blades 25 are formed as airfoils and turn under the force of lift generated by wind passing over them. The rotor blades 25 may be either fixed to the hub 24 or they may be rotatably mounted to the hub 24 depending on the turbine design. The rotor assembly 24, 25 turns a main shaft 10. As the rotor typically rotates at only a few rotations per minute, the main shaft 10 is used to drive a gear box 20 which increases the rotational speed to an appropriate level for driving a generator 7 via a high speed output shaft 6. The electrical output of generator 7 (now shown in the figure) may be fed directly to electrical storage, machinery or into a power grid. A controller (processor unit) 8 is also provided in the nacelle 23. The processor unit 8 receives inputs from an anemometer 21 and a wind vane 22 which provide the wind speed and direction respectively. The processor unit uses these measurements to determine the optimum direction for the rotor and control yaw drive 27 accordingly to turn the rotor assembly 24, 25 to the desired direction.

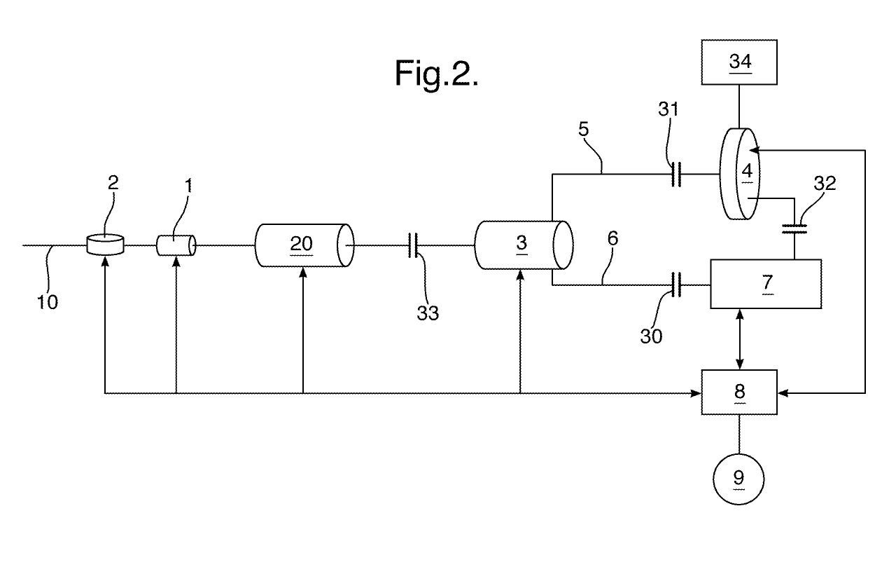

FIG. 2 shows addition features and components of one embodiment of the invention. These include a differential gear (torque distribution device) 3 which provides two outputs via shafts 5 and 6. Shaft 6 is arranged to rotate at a desired fixed speed (angular velocity) so that it can drive generator 7 at a desired constant frequency for easy matching with the power grid (not shown). Shaft 5 drives a flywheel system 4. Shaft 5 is allowed to vary in speed with the variations of speed from the rotor assembly 24, 25 which in turn varies according to wind strength and direction. Shaft 5 therefore accelerate flywheel 4 using the surplus energy which is not needed to drive generator 7. Flywheel 4 therefore accumulates the excessive energy provided by shaft 10.

It will be appreciated that although the gear box 20 is shown in FIG. 2 between the rotor assembly 24, 25 and the differential gear 3, it could in another embodiment by positioned between the differential 3 and the generator 7. In another embodiment, the generator 7 may be driven directly from the differential gear 3 which is in turn driven directly by the rotor assembly with no gear box 20 being used. Likewise, in another embodiment a gear box 20 could be positioned between the differential 3 and the flywheel system 4.

It will also be appreciated that in other embodiments the flywheel system 4 may be replaced with an alternative energy storage system which may store the surplus energy in any form, e.g. mechanically, electrically or chemically.

The flywheel system 4 can be housed in a low pressure chamber to reduce drag (this is not shown in the schematic representation of FIG. 2). The flywheel system 4 can drive its own generator 34. The flywheel 4 or its generator 34 may be fitted with sensors for the measurement of at least one of: torque, radial forces, angular velocity, angular acceleration, temperature and humidity. Mechanical properties like mass moment of inertia, mass, and all physical dimensions are known. The flywheel system 4 is connected to a processing unit (PU) 8.

The fixed speed shaft 6, operating at desired speed, is connected to a generator system 7 with a clutch 30 which enables it to be disconnected. The generator 7 is connected to the processing unit 8. Similarly, the shaft 5 is connected to the flywheel system 4 with a clutch 31 which enables it to be disconnected. A further clutch 32 and corresponding drive shafts are provided between the flywheel system 4 and the generator 7 which allow the generator 7 to be driven by the flywheel system 4 if desired. Under normal operating conditions the flywheel system 4 and its shaft 5 are not connected to the generator system 7 (i.e. clutch 32 is normally disconnected). A fourth clutch 33 is also provided in the main shaft 10 to allow the entire rotor assembly 24, 25 to be disconnected from the rest of the system. Although not illustrated in FIG. 2, the clutches 30, 31, 32, 33 are preferably controlled by the processor unit 8.

The excess power of the system, provided by an angular velocity of the shaft 10 in excess of the angular velocity required for generator 7 is transferred from shaft 10 to the flywheel system 4, via the differential gear 3 and shaft 5.

If the angular velocity of shaft 10 and/or shaft 6 are below the required value, the processing unit 8 can disconnect shaft 6 from the generator system 7 by operating clutch 30. Power from the rotor assembly 24, 25 can still be transferred in this configuration to the flywheel system 4.

Depending upon the system requirements, the system can be expanded to include a plurality of flywheel systems 4.

The location of the various components, in particular flywheel system 4, generator 7 and processor unit 8 can be at the base of the tower structure (connected for example through a hydraulic transmission system) or they can be provided in the nacelle 23 or elsewhere in the tower structure 26.

In another embodiment, shaft 6 and generator system 7 can be of a variable speed nature instead of being maintained at a constant speed. In this arrangement if the power were to be fed into a power grid, a frequency converter (not shown) would be required to convert the variable frequency output of the generator 7 into a fixed frequency for matching with the grid.

In yet further embodiments, the flywheel system(s) 4 can be individually connected to the grid.

A torque sensor 1 and a force sensor 2 are connected the main shaft 10. These sensors are arranged to monitor physical parameters of the system. The force sensor 2 can detect asymmetrical loads on the rotor system 24, 25, i.e. it can detect vibrations or wobbles of the shaft 10. Sensors 1 and 2 may be provided in the same unit.

In other embodiments an angular velocity sensor and/or an angular accelerator sensor may also be provided on shaft 10. In yet further embodiments external ambient sensors measuring wind velocities, temperature and humidity, i.e. further environmental parameter sensors may be provided. The system may also be provided with sea water and/or wave height sensors (not shown on the figures). Preferably processor unit 8 receives data from all of these sensors.

Based on input from sensors 1 and/or 2 and known physical parameters such as mass moment of inertia (Iₘ), the processing unit 8 calculates parameters like power and Iₘ* (measured mass moment of inertia) of the rotor system. The processing unit 8 can also calculate Tₘ*^{1, 2, 3 . . .} which are the calculated mass moments of inertia of the individual rotor blades.

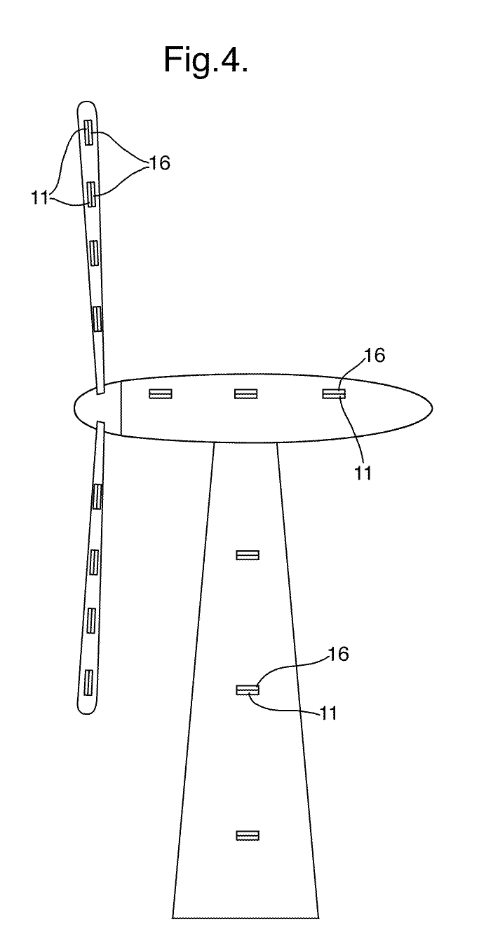

With reference to FIG. 4, the rotor system 24, 25 may also be fitted with strain gauges 35 enabling the measurement of stress and/or strain (these are also physical parameter sensors). These sensors also output data to processing unit 8. In the preferred embodiments, ultrasonic sensors are used as strain gauges.

Ultrasonic type strain sensors (physical parameter sensors) may be placed on or within the individual rotor blades 25 or at the base of the rotor blades 25 and/or on the structure 23, 26, enabling the measurement in all directions or axes (x, y, z, r, φ and/or time) of linear and non-linear material viscoelastic parameters, elasticity modulus and strain. Such measurements can form the basis of calculating bending moments and stress, and thereby subsequent calculations for the remaining lifetime of the structure 23, 26, rotor blades 25 and/or the entire wind turbine and/or the need for human intervention (maintenance or repair).

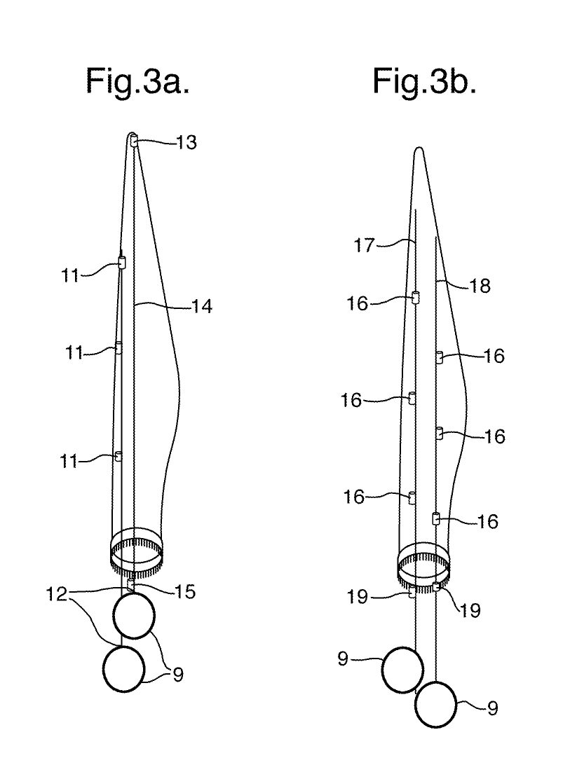

With reference to FIG. 3, the rotor blades are fitted with a plurality of sensor units 11 which are arranged to measure the temperature and/or the thickness of the rotor blades and are arranged to detect the presence and/or thickness of other material adhering to the surface of the blades 25, such as snow or ice. These sensors are connected to and controlled by processing unit 8 via connectors 12. To measure the thickness of materials, the sensor 11 is an ultrasound unit carrying at least one frequency. Units 11 are classified as both environmental and physical parameter sensors.

Physical and environmental parameter sensors are located in several strategic places on the entire windmill system (see FIG. 4). Combining the data from both environmental and physical parameter sensors, including torque sensor 1, force sensor 2 and ultrasound units 11 with Iₘ* calculations (both for individual blades 25 and for the rotor system 24, 25 as a whole), the processing unit 8 can establish the presence, quantity and the location of ice on the rotor blades. Similar calculations can be performed to detect the presence, quantity and location of ice on the other parts of the structure, including the nacelle 23.

Each individual rotor blade 25 and the tower structure 26 and nacelle 23 are fitted with a plurality of individual heat elements 16 connected together by connectors 17, 18. Elements 16 can be integrated with connectors 17, 18 making the connectors 17, 18 continuous heating elements. The heating elements 16 and connectors 17, 18 on the rotor blades 25 are connected to processor unit 8 through connection 9 and are switched on and off by the PU.

In another embodiment shown in FIG. 3b, the connectors/conductors 17, 18 can be fitted with ultrasound elements 19 carrying at least one frequency. In this case the conductors 17, 18 are ultrasound resistant and provide heat along substantially the entire length of the rotor blade 25.

Based on input from physical and environmental parameter sensors, in particular ultrasound units 11 and force and torque sensors 1, 2 and calculated parameters, in particular Iₘ* (both for the rotor system 24, 25 and for individual blades 25), the processing unit 8 will switch the heating system 16, 17, 18, 19 on and/or off at the right locations and for the required time. The heating system 16, 17, 18, 19 can include the tower structure 26 and/or the nacelle 23.

As the system continuously monitors the outputs of the sensors in real time, the system can detect not only the presence of snow/ice, but can also detect the successful removal of snow/ice, i.e. it can detect when the heating has been effective and the snow/ice has been removed. The system can therefore switch off the heating elements 16, 17, 18, 19 as soon as the job has been done and thereby minimises the energy required to do so.

Appendix A shows some calculations and derivations of relationships regarding the equivalent temperature increase caused by an acoustic wave.

When the embodiment of FIG. 2 is combined with that of FIGS. 3a and/or 3b, the processing unit 8 will preferably be arranged to provide power from the flywheel system 4 to the heating system 16, 17, 18, 19.

As shown in FIG. 3a, the individual rotor blades and other parts of the structure are fitted with lightning conductors 14 which are fitted with lightning sensors 13 enabling the measurement of electrical current and/or voltage (these sensors being considered environmental parameter sensors). Lightning conductor 14 is connected to earth via spark gaps 15 and lightning sensor 13 is also connected to the processor unit 8 through connection 12. In response to the signal from sensor 13, the processor unit 8 can shut down the generator system 7 and/or stall the rotor system 24, 25. The decision to shut down may also take account of data from the other environmental and/or physical parameter sensors discussed above in order to determine whether or not the lightning poses a risk to the wind turbine or any of its components.

If the rotor system 24, 25 is stalled, the rotors 25 are preferably placed in the most favourable position with one of the rotors in line with the tower structure. Processor unit 8 and/or other processing units communicating with processing unit 8 can be placed in the rotating hub 24.

The processor unit 8 or any other processing unit can shut down, for a defined period of time, a component, a sub-system or the entire wind turbine system if a calculated and/or environmental and/or physical parameter value is different from any predetermined value or range of values.

As well as shutting down the system based on lightning sensors 13, processor unit 8 can use the date from the other sensors including physical and/or environmental sensors such as the salt water or direct wave height sensors discussed above or strain gauges or ultrasound sensors located on the tower structure and connected to processor unit 8. In this way, processor unit 8 can detect, measure or calculate sea water levels and/or wave heights and calculate subsequent forces, bending moments, stress, and/or strain on the structure 23, 24, 25, 26, with or without the additional forces induced by winds on the structure. Based on certain criteria, e.g. forces above a certain threshold value or at wave heights above certain threshold values, processor unit 8 can stall the rotor 24, 25 and/or shut down other components of the wind turbine system, e.g. generator 7, or the entire wind turbine.

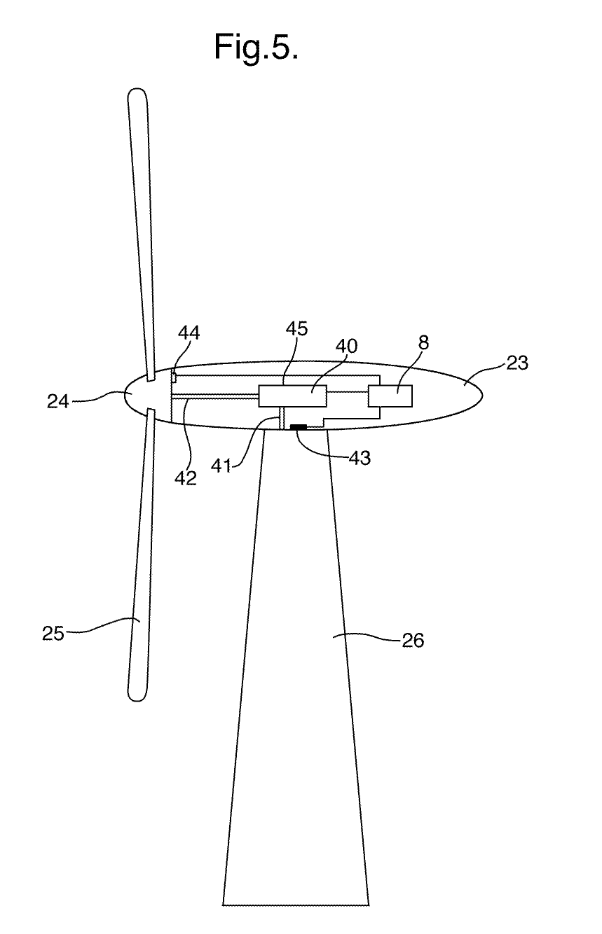

With reference to FIG. 5, to minimise maintenance and/or increase the autonomous nature of the wind turbine, the wind turbine may be provided with sensors 43, 44 for sensing fluid level and/or temperature in various grease-lubricated bearings of the turbine or its sub-systems. FIG. 5 shows a sensor 43 at the yaw bearing between the tower structure 26 and the nacelle 23 and a sensor 44 at the bearing between the rotor 24 and the nacelle 23. The sensors 43, 44 are connected to a processing unit 8 and enable direct detection (fluid level sensor) or indirect detection (temperature) of low lubrication levels in the corresponding bearings. Processor unit 8 is arranged to control a lubrication refill system 45 which comprises a reservoir 40 of lubricant and fluid connections 41, 42 which enabling replenishing of lubricants (such as grease) to the corresponding bearings.

Based on the inputs from the various physical and/or environmental parameter sensors described above, the processor unit 8 can calculate the bending moments (M^{1, 2, 3, . . .} ) of the individual rotors 25. If M is less than a given design criteria (M<M_{design}), the rotor system 24, 25 is allowed to accelerate and/or to maintain an angular velocity. If M>M_{design} (or equal to) the processor unit 8 can causes the pitch control (not shown) and/or system brakes 28 (FIG. 1) to reduce the angular velocity of the rotor system.

As mentioned above, the remote location of many wind turbines enhances the need to act autonomously and intelligently, and enhances the need to minimise downtime and/or the need for human intervention. The systems described above are designed to allow a significant amount of processing and decision making to take place at the location of the wind turbine itself. However, there will be times when some form of human intervention is required. One form of interaction between the wind turbine and humans will be simply a case of reporting a fault which has been detected and which needs human intervention for maintenance or repair. The system described above is therefore provided with communication equipment (not shown) for transmitting data to a control centre. The communication equipment may be arranged to transmit data wirelessly (e.g. via dedicated radio transmission or using the mobile telephone network) or via cables. The equipment may use a combination of wireless and wired communications or may provide them both as alternatives. If the wind turbine is connected to a power grid via power cables, the signals may be transmitted over the power cables. In this way a warning signal and/or relevant data can be transmitted to the control centre for monitoring and/or scheduling maintenance or repair.

The wind turbine (in particular processor unit(s) 8) is preferably arranged to receive data as well as to transmit data. As described above, various aspects of the system depend on threshold values which are used to determine whether certain sensed data are significant and whether or not such data warrant further action. From time to time it may be desired to update those threshold values. For example it may be decided that certain combinations of physical and environmental data are more dangerous than previously thought and therefore new threshold levels and/or threshold combinations may be uploaded to the wind turbine so as to increase its safety of operation.

In other embodiments it may also be desired to send commands to a wind turbine remotely. For example, if lubricant levels are suddenly detected to be low (e.g. due to a leak), the control centre may wish to send a remote signal to stop the entire system until repair work can be carried out. Such immediate action could prevent costly damage to the bearings from occurring before an engineer reaches the remote location of the turbine. Other commands may include forcing the entire turbine system with sub-systems to stall, to start or stop flywheel systems 4, to connect or disconnect shafts 5, 6 to generators 7, 34, to start or stop lubrication procedures, to start or stop deicing, or to connect or disconnect environmental and/or physical parameter value sensors.

In other embodiments several wind turbines are communicatively coupled to each other. The wind turbines may also be connected to a control centre. When several wind turbines are located together in a wind farm it may be advantageous for individual wind turbines to communicate directly with the other wind turbines on the farm rather than simply sending data back to a distant control centre. The connection to a distant control centre may be slow and/or unreliable, whereas the shorter distance connections between wind turbines on the same farm could be much more reliable. Wind farms cover significant areas and weather systems can sometimes travel relatively slowly (at least compared to the speed of electronic signals). Therefore there may be instances where an adverse combination of environmental factors is sensed at one side of the wind farm before those factors can affect the other side of the wind farm. In such circumstances, a signal from one wind turbine can notify all other wind turbines in the farm that a certain action should be taken, such as disengagement of generators 7 or, in extreme situations, complete shut down of the entire windmill. Such rapid action could limit damage due to the adverse conditions and could represent a significant saving on maintenance or repair costs.

The embodiments described above provide the autonomous and intelligent elimination of snow and/or ice on wind turbine components, and remove the consequences of lightning. In addition, they enhances the power output due to built-in energy retrieval and storage features, provides an intelligent lubricating system and the ability to communicate externally.

It will be appreciated that the invention is not limited to the methods and systems described above and that many variations and modifications could be made while still falling within the scope of the appended claims. Functional equivalents should also be considered as part of this invention. It should also be noted that the features of each of the above embodiments can be applied alone or in combination with the features of any of the other embodiments. A most preferred embodiment includes all the various features and systems described above.

### APPENDIX A

### Equivalent Temperature Increase by Acoustic Wave

The Root mean square velocity of thermal vibrations is given by the Boltzmann Principle of Equipartition of Energy as

$$\frac{1}{2} {mv}_{r m s}^{2} = \frac{3}{2} {k}_{B} T ⇒ {v}_{r m s} = \sqrt{\frac{3 {k}_{B}}{m} T}$$

where m is the atomic mass
k_{B} is the Boltzmann constant=1.38 10⁻²³ Joule/° K.
T is the absolute temperature in ° K.
We linearize around an environmental temperature T₀. This determines

$$\frac{3 {k}_{B}}{m} = \frac{{v}_{r m s 0}^{2}}{{T}_{0}}$$

$${v}_{r m s} = {v}_{r m s 0} \sqrt{\frac{T}{{T}_{0}}}$$

and differentiation leads to

$$\frac{d {v}_{r m s}}{d T} = \frac{{v}_{r m s 0}}{2} \frac{1}{\sqrt{{T}_{0} T}}$$

Therefore for a change of temperature ΔT

$$Δ {v}_{r m s} = \frac{{v}_{r m s 0}}{2} \frac{Δ T}{{T}_{0}} ⇔ Δ T = 2 {T}_{0} \frac{Δ {v}_{r m s}}{{v}_{r m s 0}} .$$

The vibration velocity in an elastic wave is

$${u}_{vib} = \frac{{σ}_{wave}}{{Z}_{0}}$$

$${Z}_{0} = ρ {c}_{0} - Characteristic impedance of wave \sim 2 \cdot {10}^{6} kgs \text{/} {m}^{2}$$

$${σ}_{wave} = 2 \cdot {10}^{7} Pa ⇒ {u}_{vib} = 10 m \text{/} s$$

A typical value for vᵣₘₛ₀ is ˜400 m/s at T₀=0° C.˜273° K. The elastic wave vibration velocity then represents a temperature increase of

$$Δ T = 2 \cdot 273 \cdot \frac{10}{400} \approx {14}^{∘} K .$$

This is a high energy wave though, with radiation intensity

$${I}_{wave} = \frac{{σ}_{wa ve}^{2}}{2 {Z}_{0}} = {10}^{8} W \text{/} {m}^{2} \text{:} {10}^{4} W \text{/} {cm}^{2} \text{:} 10 kW \text{/} {cm}^{2}$$

In general therefore we have the following relationships:

$${I}_{wave} = \frac{1}{2} {Z}_{0} {u}_{vib}^{2}$$

$${u}_{vib} = \sqrt{\frac{2 {I}_{wave}}{{Z}_{0}}}$$

$$Δ T = 2 {T}_{0} \frac{Δ {v}_{r m s}}{{v}_{r m s 0}} \text{:} \frac{2 {T}_{0}}{{v}_{r m s 0}} \sqrt{\frac{2 {I}_{wave }}{{Z}_{0}}}$$

We claim:

1. A wind turbine comprising:
a rotor with one or more blades;
a first shaft rotatably driven by the rotor;
a second shaft;
a third shaft; and
a torque distribution device which distributes the torque from the first shaft between the second shaft and the third shaft.

2. The wind turbine of claim 1, wherein the third shaft drives a generator for generating electricity.

3. The wind turbine of claim 2, wherein the third shaft drives a gearbox which increases the rotation speed and which drives the generator.

4. The wind turbine of claim 1, wherein the first shaft drives a gearbox which increases the rotation speed and which drives the torque distribution device.

5. The wind turbine of claim 1, wherein the third shaft can be set to rotate at a desired fixed speed.

6. The wind turbine of claim 1, wherein the torque distribution device is arranged to transfer a fixed power to the third shaft and to transfer any remaining power to the second shaft.

7. The wind turbine of claim 1, wherein the rotational speed of the third shaft is allowed to vary, wherein the third shaft drives a generator for generating electricity and wherein a frequency conversion system is attached to the generator to generate electricity at a fixed frequency.

8. The wind turbine of claim 1, wherein the torque distribution device is a differential gear.

9. The wind turbine of claim 8, wherein the differential gear is an active differential gear.

10. The wind turbine of claim 1, further comprising a first clutch mechanism which allows the third shaft to be engaged and disengaged from the first shaft.

11. The wind turbine of claim 10, wherein the first clutch is arranged to disengage the third shaft from the first shaft when the angular velocity of the first shaft drops below a threshold value.

12. The wind turbine of claim 10, further comprising a second clutch mechanism which allows the second shaft to be engaged and disengaged from the first shaft.

13. The wind turbine of claim 12, wherein the second clutch is arranged to disengage the second shaft from the first shaft when the angular velocity of the first shaft drops below a threshold value.

14. The wind turbine of claim 12, further comprising a third clutch mechanism which allows the second shaft to be engaged and disengaged from the third shaft.

15. The wind turbine of claim 1, wherein a flywheel is driven by the second shaft.

16. The wind turbine of claim 15, further comprising a second generator which can be selectively driven by the flywheel.

17. The wind turbine of claim 16, wherein the flywheel is housed in a low pressure chamber.

18. The wind turbine of claim 16, wherein the second and/or third shaft is fitted with sensors for the measurement of at least one of: torque, radial forces, angular velocity, angular acceleration, temperature and humidity.

19. The wind turbine of claim 18, wherein the sensors supply data to a processing unit.

20. The wind turbine of claim 16, wherein the second generator can be engaged and disengaged from the flywheel by means of a fourth clutch mechanism.

21. The wind turbine of claim 20 wherein the first, second, third and/or fourth clutch mechanisms are controlled by one or more processing units.

22. The wind turbine of claim 1, wherein the wind turbine is a horizontal axis wind turbine, the rotor is rotatably mounted on a nacelle which in turn is rotatably mounted on a tower structure.

23. The wind turbine of claim 22, wherein the flywheel is located in the nacelle.

24. The wind turbine of claim 22, wherein the flywheel is located near the base of the tower structure and is connected through a hydraulic transmission system.

25. A system for detecting the presence of snow and/or ice on a wind turbine, the system comprising:
one or more ultrasound sensors arranged to monitor the surface of the turbine structure.

26. The system of claim 25, wherein the or each ultrasound sensor is arranged to send data to a processing unit.

27. The system of claim 25, wherein the wind turbine comprises a rotor with one or more blades and wherein at least one ultrasound sensor is arranged to monitor the surface of each rotor blade.

28. The system of claim 25, wherein the wind turbine comprises a nacelle on which a rotor is mounted and wherein at least one ultrasound sensor is arranged to monitor the surface of the nacelle.

29. The system of claim 25, wherein the wind turbine comprises a tower structure on top of which a rotor is mounted and wherein at least one ultrasound sensor is arranged to monitor the surface of the tower structure.

30. The system of claim 25, wherein the or each ultrasound sensor is arranged inside the structure and is arranged to monitor the thickness of the surface and any surface deposits.

31. The system of claim 25, wherein the or each ultrasound sensor is arranged on the surface of the structure and is arranged to monitor the thickness of any surface deposits.

32. The system of claim 25, the system further comprising a torque sensor and/or a force sensor and/or an angular velocity sensor and/or an angular acceleration sensor for sensing physical parameters of a main shaft of the wind turbine and wherein the or each sensor sends data to a processing unit.

33. The system of claim 25, the system further comprising one or more strain sensors for sensing the strain in the turbine structure and wherein the or each sensor sends data to a processing unit.

34. The system of claim 33, wherein the or each strain sensor is an ultrasound sensor.

35. The system of claim 25, the system further comprising a wind speed sensor and/or a wind direction sensor and/or a temperature sensor and/or a humidity sensor for sensing environmental parameters and wherein the or each sensor sends data to a processing unit.

36. The system of claim 32, wherein the processing unit is arranged to analyse the data and to determine whether or not ice and/or snow may be present on the turbine structure.

37. The wind turbine comprising a system as claimed in claim 25 and further comprising one or more heating elements.

38. The wind turbine of claim 37, wherein the heating elements are selectively operable.

39. The wind turbine of claim 37, wherein the or each heating element is arranged to be operated only when snow and/or ice is detected in the vicinity of that heating element.

40. The wind turbine of claim 37, wherein the or each heating element is an ultrasound transmitter.

41. The wind turbine of claim 37, wherein the or each heating element is an ultrasound transducer and also serves as one of the sensors for monitoring the surface of the structure.

42. A wind turbine comprising:
at least one sensor for sensing the presence of snow and/or ice on the surface of the wind turbine in real time;
at least one heating element for melting snow and/or ice on the surface of the wind turbine; and
a processing unit arranged to receive data from the at least one sensor and arranged to activate and deactivate the heating element;
wherein the processing unit is arranged to activate the heating unit when the at least one sensor indicates the presence of snow and/or ice and wherein the processing unit is arranged to deactivate the heating unit when the at least one sensor no longer indicates the presence of snow and/or ice.

43. The wind turbine of claim 42, wherein the at least one sensor includes at least one ultrasound sensor arranged to monitor the thickness of snow and/or ice on the surface of the wind turbine.

44. The wind turbine of claim 42, wherein the at least one heating element includes at least one ultrasound transmitter.

45. The wind turbine of claim 42, wherein the at least one sensor includes at least one torque sensor and/or force sensor and/or angular velocity sensor and/or angular acceleration sensor and/or strain sensor arranged to monitor a rotor of the wind turbine.

46. The wind turbine of claim 42, wherein the or each heating element is powered from a flywheel.

47. A wind turbine comprising a lightning sensor for detecting the presence of lightning and sending data to a processing unit, wherein the processing unit is arranged to shut down one or more components or sub-systems of the wind turbine or the whole wind turbine for a defined period of time based on the data received from the lightning sensor.

48. The wind turbine of claim 47, wherein the lightning sensor is more than one sensor.

49. The wind turbine of claim 47, wherein the processing unit is arranged to take account of data received from other environmental and/or physical sensor within the system when performing the shutdown.

50. The wind turbine of claim 47, wherein the processing unit is arranged to perform the shutdown when the sensed data is outside a predetermined range.

51. A wind turbine comprising:
one or more lubricated components;
a lubrication refill system; and
one or more sensors for monitoring the lubricant level in the or each lubricated component;
wherein the lubrication refill system is arranged to refill the or each component with lubricant when the or each sensor indicates that the lubricant level has fallen below a threshold value.

52. A wind farm comprising a plurality of wind turbines, wherein at least one wind turbine is communicatively coupled to at least one other wind turbine.

53. The wind farm of claim 52, wherein at least one wind turbine is a master wind turbine which is communicatively coupled to a control centre.

54. The wind farm of claim 53, wherein the at least one master wind turbine is arranged to transmit and receive data to/from the control centre and is arranged to transmit and receive data to/from each other wind turbine in the farm.

55. The wind farm of claim 52, wherein each wind turbine is communicatively coupled to each other wind turbine on the farm.

56. The wind farm of claim 55, wherein the plurality of wind turbines are communicatively networked for exchange of data.
